(19) United States
(12) Patent Application Publication
(10) Pub. No.: US 2013/0284958 A1
(43) Pub. Date: Oct. 31, 2013

(54) PRESSURE AUGMENTATION VALVE

(71) Applicants: Anthony R. Gomez, Miami, FL (US); Ramon A. Gomez, Miami, FL (US)

(72) Inventors: Anthony R. Gomez, Miami, FL (US); Ramon A. Gomez, Miami, FL (US)

(21) Appl. No.: 13/456,763

(22) Filed: Apr. 26, 2012

(51) Int. Cl. F15D 1/02; F16L 55/027; F16K 17/04

(52) U.S. Cl. 251/118; 251/322; 138/40

(57) ABSTRACT

The pressure augmentation valve includes a substantially tubular element having a lumen, a ring located along an interior surface of the tubular element and a dam element located in the lumen, wherein the dam element includes at least one cutout area. The valve further includes a movable plug located in the lumen between the ring and the dam element, wherein at least a portion of the plug includes a diameter greater than an interior diameter of the ring, and a spring positioned between the plug and the dam element, such that the spring exerts a force against the plug in a direction of the ring. The plug exerts a force against fluid entering the tubular element via the ring, thereby increasing pressure of the fluid upon exiting the dam element.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of fluid conveyance, and more particularly relates to the field of valves for adjusting fluid pressure in the course of fluid conveyance.

### BACKGROUND OF THE INVENTION

Fluid conveyance encompasses the use of pipes to convey substances that can flow, i.e., liquids and gases (fluids), slurries, powders, and masses of small solids. In the art of fluid conveyance it is often desired to increase fluid pressure. In the field of plumbing, for example, there can be a desire to increase water pressure to better serve showers and sinks in a home or commercial structure. Neighborhoods and industrial areas are sometimes afflicted with low water pressure from the public water supply system, which affects the ability of individuals to utilize certain devices that require a minimum amount of water pressure to operate, such as fire hoses and water sprinklers. There are few solutions to this problem and therefore users must often simply cope with the difficulty.

One approach to the above-described problem is the installation of a pressure infuser device, which comprises a pressurized container that is attached to the low-pressure fluid conveyance system. The pressure infuser device releases the contents of its pressurized container into the low-pressure fluid conveyance system, thereby increasing the pressure inside the fluid conveyance system. The drawback with this approach is the high cost associated with installing a large pressurized container in a residential, commercial or industrial setting and maintaining a high pressure within the container. Another drawback of this approach is the large footprint of the pressure infuser device, which is not practical in many residential and commercial properties in urban areas or industrial settings where space is at a premium.

Therefore, a need exists to overcome the problems with the prior art as discussed above, and particularly for a more efficient way of increasing pressure in a fluid conveyance system.

### SUMMARY OF THE INVENTION

Briefly, according to one embodiment, a pressure augmentation valve for a fluid conveyance system is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

The pressure augmentation valve includes a substantially tubular element having a lumen, a ring located along an interior surface of the tubular element and a dam element located in the lumen, wherein the dam element includes at least one cutout area. The pressure augmentation valve further includes a movable plug located in the lumen of the tubular element between the ring and the dam element, wherein at least a portion of the plug includes a diameter greater than an interior diameter of the ring and a spring positioned between the plug and the dam element such that the spring exerts a force against the plug in a direction of the ring. The plug exerts a force against fluid entering the tubular element via the ring, thereby increasing pressure of the fluid upon exiting the dam element. In a second embodiment, the pressure augmentation valve further comprises a bolt that extends through an orifice extending from an exterior surface of the tubular element to the lumen such that the bolt contacts the dam element and secures the dam element in the lumen.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is an illustration of a cutout perspective view of the pressure augmentation valve, in accordance with one embodiment.

FIG. 2 is an illustration of a side cross-sectional view of the pressure augmentation valve, in accordance with one embodiment.

FIG. 3 is an illustration of a perspective view of the dam element of the pressure augmentation valve, in accordance with one embodiment.

FIG. 4 is an illustration of a perspective view of the plug element of the pressure augmentation valve, in accordance with one embodiment.

FIG. 5 is a block diagram showing a general fluid conveyance system that may utilize the pressure augmentation valve, in accordance with one embodiment.

FIG. 6 is a block diagram showing a general plumbing system that may utilize the pressure augmentation valve, in accordance with one embodiment.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

In accordance with the embodiments described herein, a pressure augmentation valve is disclosed that solves problems with the prior art by providing a simple pressure augmentation valve that increases fluid pressure within a fluid conveyance system above that of a fluid source with inadequate pressure. The increase in fluid pressure results in higher pressure during exit of the fluid from an outlet of the fluid conveyance system. In the field of plumbing, for example, the increase in water pressure results in higher pressure water exiting showers, sinks, fire hoses and water sprinklers, thereby increasing the utility of the aforementioned fluid outlets. The pressure augmentation valve contains a minimum of moving parts, resulting in a valve that is easy and inexpensive to manufacture and decreases the probability of malfunction. The pressure augmentation valve further comprises a small footprint, which facilitates its installation and requires little, if any, accommodation of space. Lastly, an increase in water pressure at water outlets, such as showers, sinks, and water sprinklers, results in a reduction in consumption of water. This is advantageous since the price of water has increased over time and water conservation has become a more prominent social issue.

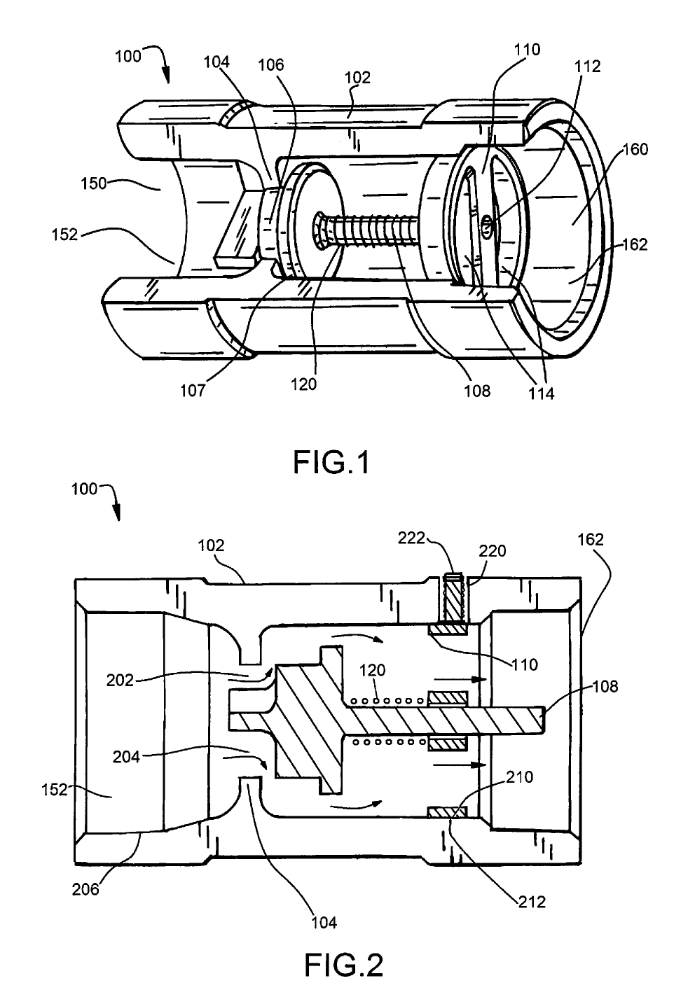

FIG. 1 is an illustration of a cutout perspective view of the pressure augmentation valve 100, in accordance with one embodiment. It should be noted that FIG. 1 shows the pressure augmentation valve 100 in a plugged or closed state. FIG. 1 shows that the pressure augmentation valve 100 includes a substantially tubular element, such as a pipe, 102 having a lumen comprising the interior volume of the tubular element 102. The tubular element 102 includes a first orifice 152 at a first end 150 for ingress of fluid and a second orifice 162 at a second end 160 for egress of fluid. FIG. 1 also shows a ring 104 located along an interior surface of the tubular element 102. The ring 104 has a smaller interior diameter than the interior diameter of the tubular element 102. Since the cross sectional area of the opening of ring 104 is smaller than the cross sectional area of the opening of the tubular element 102 (such as orifice 152), fluid pressure increases as it moves from a larger cross-sectional area in pipe 102 to a smaller cross-sectional area in the opening of ring 104.

FIG. 1 further includes a dam element 110 located in the lumen, wherein the dam element 110 comprises a disc having at least one cutout area 114. The dam element 110 is named as such because it acts like a dam—i.e., the dam element 110 impounds or inhibits fluid from passing it. FIG. 1 shows that dam element 110 includes substantially a disc concentric with the pipe 102 and having at least two cutout areas 114 located on either side of a circular orifice 112 in the center of the disc.

The pressure augmentation valve 100 also includes a movable plug 106 located in the lumen between the ring 104 and the dam element 110. The movable plug 106 comprises substantially a cylindrical shaped element situated concentrically with the tubular element 102. The cylindrical shaped element has an exterior diameter that is substantially identical to the interior diameter of the ring 104. At least a portion 107 of the plug 106 includes a diameter greater than the interior diameter of the ring 104. The plug 106 further includes a shaft 108 that is situated concentrically to the tubular element 102 and that extends from the center of the cylindrical shaped element of the plug 106 to the dam element 110. The shaft 108 may extend into the circular orifice 112 in the center of the dam element 110.

Finally, the pressure augmentation valve 100 includes a spring 120 positioned between the plug 106 and the dam element 110, such that the spring 120 exerts a force against the plug 106 in a direction of the ring 104. When there is no fluid pressure asserted against the plug 106, as shown in FIG. 1, the spring 120 pushes the cylindrical shaped element of plug 106 to extend at least partially into the opening of the ring 104, such that the lumen of tubular element 102 is completely plugged and fluid cannot pass through it. When there is ingress of fluid into the tubular element 102 via orifice 152 and there is an adequate amount of fluid pressure asserted against the plug 106 to override the force of the spring 120 pushing against the plug 106, as shown in FIG. 2, the plug 106 moves back against the spring 120 such that no portion of the cylindrical shaped element of plug 106 extends into the opening of the ring 104. In this case, fluid may pass through the lumen of tubular element 102 (see arrows in FIG. 2). It should be noted, however, that since plug 106 exerts a force against fluid entering the tubular element 102 via the orifice 152 and through the ring 104, this results in an increase in fluid pressure as it flows through the dam element 110 and exits the orifice 162.

FIG. 2 is an illustration of a side cross-sectional view of the pressure augmentation valve 100, in accordance with one embodiment. It should be noted that FIG. 2 shows the pressure augmentation valve 100 in an open state. Note that FIG. 2 shows that an interior diameter 206 of the tubular element 102 gradually decreases from the orifice 152 to the ring 104. This results in an increase in fluid pressure since fluid increases in pressure when it flows from a larger cross-sectional area to a smaller cross-sectional area. Note also that FIG. 2 shows that spring 120 extends around shaft 108.

In one embodiment, the exterior surface of the dam element 110 may include a threaded surface 210 that interfaces with a threaded surface 212 in the interior surface of the tubular element 102 so as to secure the dam element 110 in the lumen of the tubular element 102.

In another embodiment, the pressure augmentation valve 100 further comprises an orifice 220 extending from an exterior surface of the tubular element 102 to the lumen such that the orifice 220 is adjacent to the dam element 110. The interior surface of the orifice 220 may be threaded so as to accept a threaded bolt or screw 222. In this embodiment, the pressure augmentation valve 100 further comprises a threaded bolt 222 that extends through the orifice 220 extending from the exterior surface of the tubular element 102 to the lumen such that the bolt 222 contacts the dam element 110 and secures the dam element 110 in the lumen. The purpose of the bolt 222 is to secure the dam element 110 in place in the lumen. When the location of the dam element 110 is desired to be adjusted, the bolt 222 must be retracted so as to allow the dam element 110 to be moved. Once the dam element 110 is positioned in the desired place, the bolt 22 is once again tightened so as to place pressure against the dam element 110 and hold it in place.

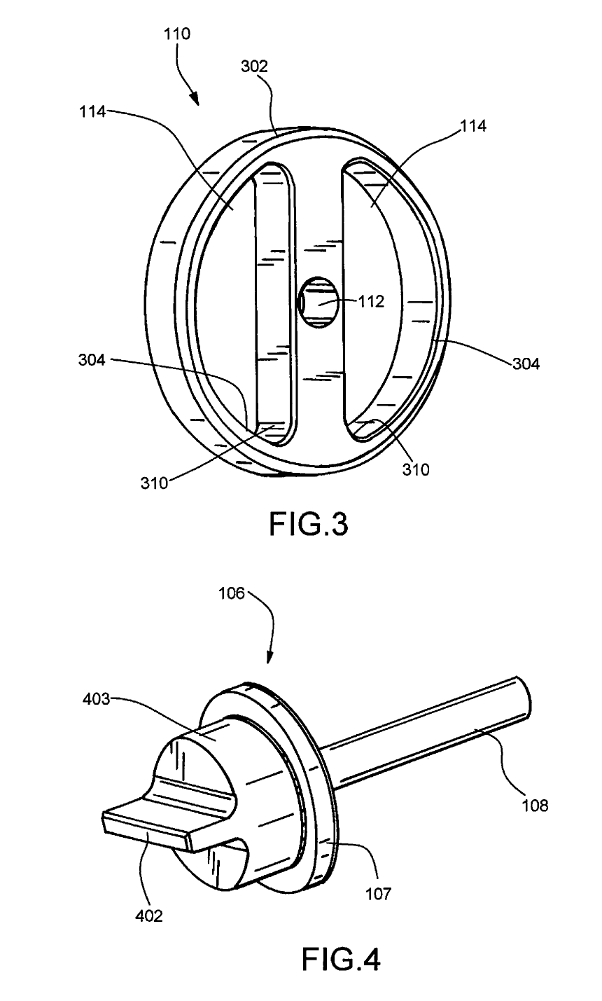

FIG. 3 is an illustration of a perspective view of the dam element 110 of the pressure augmentation valve 100, in accordance with one embodiment. Recall the dam element 110 comprises a disc having at least one cutout area 114. FIG. 3 shows at least two cutout areas 114 located on either side of a circular orifice 112 in the center of the disc, wherein each cutout area 114 comprises a substantially semi-circular shape having rounded corners. FIG. 3 also shows that the outside circular edge 302 of dam element 110 may be rounded. Further, the inside edges 304 of the two cutout areas 114 may also be rounded. The purpose of the cutout areas 114 is to allow fluid to pass through the dam element 110. But since the cross sectional area of the cutout areas 114 is smaller than the cross sectional area of the tubular element 102, fluid pressure increases as it moves from the larger cross-sectional area of pipe 102 to the smaller cross-sectional area of cutouts 114. The purpose of circular orifice 112 is to secure the shaft 108 of plug 106 in place along the main central axis of the tubular element 102 as the plug 106 moves back and forth when fluid pressure fluctuates.

It should be noted that the position of the dam element 110 within the lumen of tubular element 102 may be adjusted to accommodate various fluid pressures. In a situation where fluid pressure is relatively low, the fluid pressure may be too low to override the force of the spring 120 and move the plug 106 back. In this case, the dam element 110 may be moved back towards the orifice 162, so as to increase the distance between the ring 104 and dam element 110, which lessens the force of the spring 120 against the plug 106. This allows fluid at lower pressures to move the plug 106 back and allow fluid to pass through the ring 104. In a situation where fluid pressure is relatively high, the fluid pressure may be so high that it overshadows the force of the spring 120. In this case, the dam element 110 may be moved forward towards the orifice 152, so as to decrease the distance between the ring 104 and dam element 110, which increases the force of the spring 120 against the plug 106. This allows fluid at higher pressures to experience the effect of the plug 106 on fluid flow as it passes through the ring 104. In summary, the position of the dam element 110 within tubular element 102 may be adjusted to maintain the utility of the valve 100 at various fluid pressures.

FIG. 4 is an illustration of a perspective view of the plug element 106 of the pressure augmentation valve 100, in accordance with one embodiment. Recall that the movable plug 106 comprises substantially a cylindrical shaped element 403 situated concentrically with the tubular element 102. The cylindrical shaped element 403 has an exterior diameter that is substantially identical to the interior diameter of the ring 104 so that when there is no fluid pressure asserted against the plug 106, the cylindrical shaped element of plug 106 may extend at least partially into the opening of the ring 104, thereby plugging the orifice created by ring 104. Note that portion 107 of the plug 106 includes a diameter greater than the interior diameter of the ring 104 so that when there is no fluid pressure asserted against the plug 106, the portion 107 contacts the ring 104 and creates a seal with the ring 104 so as to prevent fluid from passing through the ring 104. The plug 106 further includes a shaft 108 that extends from the center of the cylindrical shaped element of the plug 106 into the circular orifice 112 in the center of the dam element 110.

FIG. 4 also shows that plug element 106 includes a planar element or tab 402 situated on top of the cylindrical element of plug 106. The tab 402 extends the diameter of the cylindrical element of plug 106. The width of the tab 402 is identical to the diameter of the cylindrical element of plug 106 and recall that the diameter of the cylindrical element of plug 106 is substantially identical to the interior diameter of the ring 104. As the plug 106 moves back against the spring 120 due to fluid pressure, the cylindrical element of plug 106 moves out of the opening of ring 104 but the tab 402 remains in the opening of ring 104. The purpose of the tab 402 is to secure the plug 106 in place along the main central axis of the tubular element 102 as the plug 106 moves back and forth when fluid pressure fluctuates. Another purpose of tab 402 is to allow fluid to pass through the ring 104 when there is adequate water pressure to override the force of the spring 120 pushing against the plug 106. When the plug 106 moves back against the spring 120 and the cylindrical element of plug 106 moves out of the opening of ring 104, the tab 402 remains in the opening of ring 104 but openings 202, 204 (see FIG. 2) exist on either side of the tab 402 that allow fluid to pass through the opening of ring 104. In this case, note that since the cross sectional area of the openings 202, 204 is smaller than the cross sectional area of the tubular element 102, fluid pressure increases as it moves from the larger cross-sectional area of pipe 102 to the smaller cross-sectional area of openings 202, 204.

In one embodiment, one or more of the components of the pressure augmentation valve 100 may be composed of brass, bronze, polyvinyl chloride (PVC/uPVC), chlorinated polyvinyl chloride (CPVC), acrylonitrile butadiene styrene (ABS), ductile iron, steel, cast iron, carbon steel, stainless steel, alloy steel, polypropylene, polyethylene, or copper. In another embodiment, the pressure augmentation valve 100 may include a gasket placed over potion 107 of plug 106, wherein the gasket may be composed of gasket paper, rubber, silicone, metal, cork, felt, neoprene, nitrile rubber, fiberglass, polytetrafluoroethylene (PTFE) or a plastic polymer (such as polychlorotrifluoroethylene).

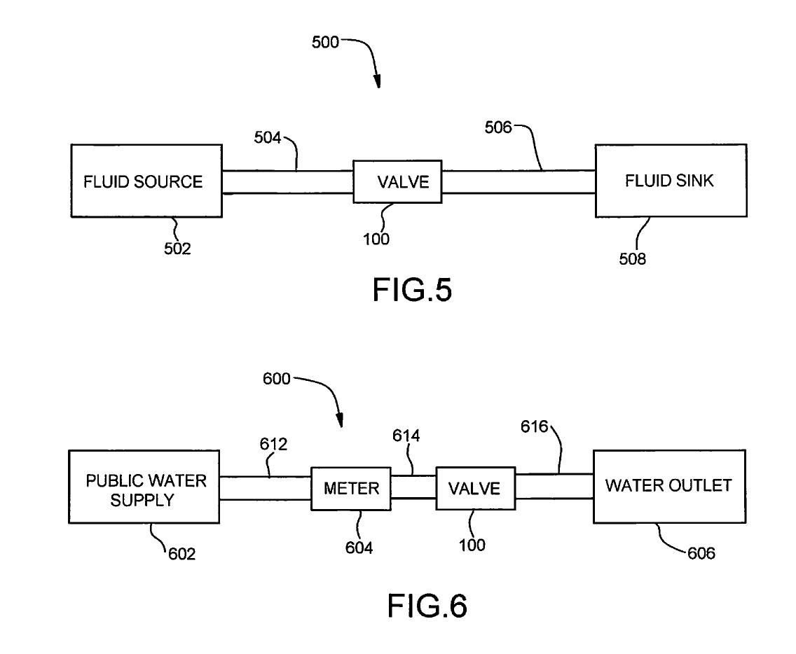

FIG. 5 is a block diagram showing a general fluid conveyance system 500 that may utilize the pressure augmentation valve 100, in accordance with one embodiment. FIG. 5 shows a fluid source 502 that provides the source of a fluid at a first fluid pressure. The fluid source 502 may be, for example, a fluid pump or a container comprising fluid at a particular fluid pressure. The fluid from the fluid source 502 enters the fluid conveyance system 504, such as a set of pipes, at the first fluid pressure. The valve 100 is operatively coupled with the fluid conveyance system 504. As the fluid passes through the valve 100, the valve 100 increases the fluid pressure above that of the first fluid pressure, as described in more detail above. Thus, the fluid passes through the valve 100 into the fluid conveyance system 506 at a second, higher fluid pressure. Consequently, the fluid exits the fluid sink 508 at the second, higher fluid pressure. The fluid sink 508 may be, for example, an outlet such as a spray nozzle, a spigot or a tap.

FIG. 6 is a block diagram showing a general plumbing system 600 that may utilize the pressure augmentation valve 100, in accordance with one embodiment. FIG. 6 shows a fluid source comprising the public water supply 602, which supplies water at a first water pressure. The water from the public water supply 602 enters the public water pipe system 612 at the first water pressure. The water meter 604 is a device operatively coupled with the public water pipe system 612 and measures the volume of water usage at the water outlet 606. After passing through the water meter 604, the water enters the water pipe 614. The valve 100 is operatively coupled with the water pipe 614. As the water passes through the valve 100, the valve 100 increases the water pressure above that of the first water pressure, as described in more detail above. Thus, the water passes through the valve 100 into the water pipe(s) 616 at a second, higher water pressure. Consequently, the water exits the water outlet 606 at the second, higher water pressure. The water outlet 606 may be, for example, a water tap, a shower head, a water hose or a spigot.

While certain embodiments of the invention have been described, other embodiments may exist. Furthermore, although embodiments of the present invention have been described as being associated with water, the present invention also supports other types of fluids. Although the subject matter has been described in language specific to structural features, it is to be understood that the subject matter defined in the appended claims is not necessarily limited to the specific features or acts described above. Rather, the specific features and acts described above are disclosed as example forms of implementing the claims.

The Applicant conducted various experiments in 2011 to quantify the amount of the reduction in fluid consumption that was experienced when using a prototype of the pressure augmentation valve 100, which was substantially identical to the pressure augmentation valve 100 described in this specification. The experiment consisted of: a) installing the pressure augmentation valve 100 at a commercial property, b) measuring the water consumption of the commercial property over a 90 day period using a water meter, and c) comparing the water consumption readings with water consumption readings of the commercial property for a similar 90 day period from the prior year. The experimental results showed that for a 90-day period using the pressure augmentation valve, 61,112 gallons of water were consumed at the commercial property, for a daily water consumption average of 679 gallons of water. Water consumption readings of the commercial property for a similar 90 day period from the prior year, however, showed 155,584 gallons of water were consumed at the commercial property, for a daily water consumption average of 1729 gallons of water. Thus, experimental results showed a 60.7% reduction in consumption of water when the pressure augmentation valve 100 was utilized at the commercial property.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A pressure augmentation valve, comprising:
a substantially tubular element having a lumen;
a ring located along an interior surface of the tubular element;
a dam element located in the lumen, wherein the dam element includes at least one cutout area;
a movable plug located in the lumen of the tubular element between the ring and the dam element, wherein at least a portion of the plug includes a diameter greater than an interior diameter of the ring; and
a spring positioned between the plug and the dam element such that the spring exerts a force against the plug in a direction of the ring;
wherein the plug exerts a force against fluid entering the tubular element via the ring, thereby increasing pressure of the fluid upon exiting the dam element.

2. The pressure augmentation valve of claim 1, wherein the tubular element includes a first orifice at a first end for ingress of fluid and a second orifice at a second end for egress of fluid.

3. The pressure augmentation valve of claim 2, wherein an interior diameter of the tubular element gradually decreases from the first orifice to the ring.

4. The pressure augmentation valve of claim 3, wherein the ring is located in closer proximity to the first orifice than the second orifice.

5. The pressure augmentation valve of claim 2, wherein the dam element comprises substantially a disc concentric with the tubular element and having at least two cutout areas.

6. The pressure augmentation valve of claim 5, wherein the dam element includes a circular orifice in its center.

7. The pressure augmentation valve of claim 6, wherein the dam element comprises two cutout areas, each cutout area comprising a substantially semi-circular shaped cutout located on either side of the circular orifice.

8. The pressure augmentation valve of claim 6, wherein an exterior surface of the dam element includes a threaded surface that interfaces with a threaded surface in the interior surface of the tubular element so as to secure the dam element in the lumen of the tubular element.

9. The pressure augmentation valve of claim 8, wherein the plug comprises a substantially cylindrical element and wherein an external diameter of the cylindrical element is substantially identical to the interior diameter of the ring.

10. The pressure augmentation valve of claim 9, wherein the at least a portion of the plug comprises a portion of the cylindrical element wherein the external diameter of the cylindrical element is substantially greater than the interior diameter of the ring.

11. The pressure augmentation valve of claim 10, wherein the plug further comprises a segment of the cylindrical element extending through the ring, wherein at least a portion of the segment has an external diameter less than the interior diameter of the ring.

12. The pressure augmentation valve of claim 11, wherein the plug further comprises a shaft concentric with the tubular element and extending from the cylindrical element into the orifice of the dam element.

13. The pressure augmentation valve of claim 12, wherein the spring extends around the shaft from the cylindrical element of the plug to the dam element

14. The pressure augmentation valve of claim 13, further comprising an orifice extending from an exterior surface of the tubular element to the lumen such that the orifice is adjacent to the dam element.

15. The pressure augmentation valve of claim 14, further comprising a threaded bolt that extends through the orifice extending from the exterior surface of the tubular element to the lumen such that the bolt contacts the dam element and secures the dam element in the lumen.

16. A pressure augmentation valve, comprising:
a pipe having a lumen;
a ring located along an interior surface of the pipe;
a disc located in the lumen concentric with the pipe, wherein the disc includes at least one cutout area;
a movable plug located in the lumen between the ring and the disc, wherein at least a portion of the plug includes a diameter greater than an interior diameter of the ring;
a spring positioned between the plug and the disc such that the spring exerts a force against the plug in a direction of the ring; and
a bolt that extends through an orifice extending from an exterior surface of the pipe to the lumen such that the bolt contacts the disc and secures the disc in the lumen;
wherein the plug exerts a force against fluid entering the pipe via the ring, thereby increasing pressure of the fluid upon exiting the disc.

17. The pressure augmentation valve of claim 16, wherein an interior diameter of the pipe gradually decreases from a first orifice in a first end of the pipe to the ring.

18. The pressure augmentation valve of claim 17, wherein the disc comprises two cutout areas, each cutout area comprising a substantially semi-circular shaped cutout.

19. The pressure augmentation valve of claim 18, wherein the plug further comprises a shaft concentric with the pipe and extending from the plug to the disc.

20. The pressure augmentation valve of claim 19, wherein the disc further includes a circular orifice in its center, and wherein the shaft extends through the circular orifice.
